(19) United States
(12) Patent Application Publication
(10) Pub. No.: US 2004/0179575 A1
(43) Pub. Date: Sep. 16, 2004

(54) Instrument for temperature and condition monitoring of advanced turbine blades

(76) Inventor: James R. Markham, Middlefield, CT (US)

Correspondence Address: Ira S. Dorman, Suite 200, 330 Roberts Street, East Hartford, CT, 06108, US

(21) Appl. No.: 10/755,424

(22) Filed: Jan. 12, 2004

Related U.S. Application Data
(60) Provisional application No. 60/442,181, filed on Jan. 23, 2003.

(51) Int. Cl. G01J 5/00

(52) U.S. Cl. 374/121; 374/130

(57) ABSTRACT

An on-engine radiation thermometer that simultaneously measures, through a common optical waveguide probe, long wavelength infrared radiation and short wavelength radiation, enables accurate temperature measurement and condition monitoring of ceramic thermal barrier coatings used on metal blades of gas turbine engines. This in turn enables operation at higher combustion temperatures, thereby optimizing coating use, and provides warning signals that are indicative of potential blade failure due to barrier coating spall and other conditions.

### CROSS-REFERENCE TO RELATED APPLICATION

This application claims the benefit of U.S. Provisional Patent Application No. 60/442,181, filed Jan. 23, 2003. The entire specification of the aforesaid Provisional Patent Application is incorporated hereinto by reference thereto.

### STATEMENT REGARDING GOVERNMENT INTEREST

The United States Government has rights in this invention under Department of Energy Contract No. DE-FG02-01ER83138.

### BACKGROUND OF THE INVENTION

This invention is directed to a radiation thermometer comprised of a unitary optical waveguide for transmission of both short wavelength infrared and/or visible radiation, and long wavelength infrared radiation, which is particularly adapted for temperature and condition monitoring of ceramic thermal barrier-coated blades in advanced gas turbine engines.

The measurement of surface temperature from traditional metal-bladed turbines has, for many years, been a well-utilized diagnostic. Radiation thermometry (non-contact optical pyrometry) has been successfully applied for measuring the surface temperature of first-stage stationary and rotating airfoils by detecting hot-part thermal radiation at wavelengths in the 1.0 μm region of the near-infrared spectrum. These short wavelength infrared (SWIR) pyrometers provide surface-temperature information from oxidized metal parts, whose short wavelength radiative properties are favorable to such measurements; i.e., they exhibit high emittance (˜0.9), low reflectance (˜0.1) and no transmittance.

Ceramic thermal barrier coatings (TBCs) are now widely used on metal turbine blades, and permit engines to operate at higher temperatures for increased power, improved fuel efficiency, and reduced emissions into the environment. However, ceramics that show promise as TBCs have low, variable emittance, as well as significant reflectance and transmittance at short wavelengths, leading to increased uncertainties of measurement for SWIR pyrometry; combustion reflection from the TBC, and optical penetration through the TBC, are also significant.

On the other hand, TBC emittance in the long wavelength infrared (LWIR), particularly the 10 μm region, is known to be of near-blackbody character and to enable surface temperature measurement with minimal penetration. Recent publications (see Markham, J. R. and Kinsella, K., “Thermal Radiative Properties and Temperature Measurements From Turbine Coatings,” International Journal of Thermophysics, 19(2) 538-545 (1998); and Latvakoski, H., Markham, J., Borden, M., Hawkins, T., Cybulski, M., “Measurement of Advanced Ceramic Coated Superalloys With a Long Wavelength Pyrometer,” Paper # AIAA 2000-2212 presented at the 21^{st} AIAA Advanced Measurement Technology and Ground Test Conference, Denver, Colo. (Jun. 19-22, 2000)) have described LWIR pyrometers for TBC temperature monitoring from atmospheric test rigs and from within high-pressure gas turbine engines. Flexible hollow waveguides were demonstrated to transfer the LWIR that is not accessible with traditional solid-core fiber optics used for SWIR pyrometers, enabling measurement of surface temperatures of TBC metal bars mounted on a rotating rig and providing insight into the temperature contribution to the metal bar from nearby radiation sources reflecting from the surface. Moreover, the high-speed radiation thermometer described by Markham, in U.S. Pat. No. 6,364,524, employs a hollow waveguide for transferring radiation, emitted by TBC blades of a gas turbine rotor, through the hollow core to an LWIR detection system.

At atmospheric pressure, LWIR band passes can be chosen that match the near-blackbody wavelength region for TBCs so as not to overlap with the LWIR emission/absorption signature of the major combustion gas products (i.e., carbon dioxide and water). It is known however that, as pressure is increased the gas signatures broaden to result in significant interference that is pathlength dependent; recently reported on-engine LWIR TBC turbine blade temperature measurements applied a correction to account for the combustion gases in the optical beam path (see Markham, J. R., Latvakoski, H. M., Frank, S. L. F., and Lütke, M., “Simultaneous Short and Long Wavelength Infrared Pyrometry Measurements in a Heavy Duty Gas Turbine,” paper 2001-GT-0026 presented at the 46^{th} ASME International Gas Turbine & Aeroengine Technical Congress (Turbo Expo 2001, June 4-7, New Orleans, La.)). The HITEMP spectral database of the wavelength-dependent emission/absorption features for H₂O and CO₂, as a function of temperature, has been used, together with the measured gas temperature and pressure at the turbine, to predict the extent of interference intruded into the gas path over the distance from the optical probe to the point on the blade being measured (accounting for the changing distance due to blade curvature).

Previous analysis of SWIR data from an uncoated metal turbine concluded that SWIR measurements from oxidized metal parts yield reasonable results in the presence of natural gas flame radiation, whereas a suitable flame radiation correction is essential for the more broadband-radiating sooty fireball of fuel oil; a sooty fireball would have even more influence in the SWIR from TBC, the reflectance of which is higher than that of oxidized metal. However, LWIR measurements from the TBC turbine show a consistency when natural gas firing is compared to fuel oil firing.

FIG. 1 of the appended drawings are LWIR temperature traces collected from a first stage turbine, which show the blade-to-blade temperature variations to be consistent for both operating conditions of the engine (e.g., leading edges labeled as “a” and “b”). Although the absolute temperatures are proprietary to the engine manufacturer, the scales are consistent for each fuel. Viewing the maximum temperatures (which are on the pressure surface between cooling lines), it is observed that the liquid fuel case (180 MW output) presents a slightly higher temperature than the natural gas case (170 MW output). This turbine held 80 blades, 73 with full TBC and seven adjacent blades (numbers 33-39), which clearly stand out in each trace, having their pressure surfaces stripped of TBC. Four of the seven stripped blades (i.e., numbers 33-36) had an internal air-cooling pattern that was different from that of the remaining three which, except for blade 20, had the same cooling pattern as all the other TBC blades; blade 20, which had a unique cooling pattern, stands out in both traces as different from the majority.

A SWIR pyrometer was utilized simultaneously during the foregoing LWIR pyrometer measurements (see Markham, J. R., et al., “Simultaneous Short and Long Wavelength Infrared Pyrometry Measurements . . . ,” supra). The LWIR and SWIR instruments employed separate intrusion probes extending into the combustion gas path (i.e., through two separate holes in the engine case) to target the same measurement spot on the turbine, but at different instants of time. The probes were mutually disposed at an angle of 110° down the rotational axis of the turbine, providing sampling from the left and right sides of the engine. Both focused optics were aimed downstream, allowing the turbine rotation to sweep the field-of-view with the leading edge and most of the pressure surface of each first-stage blade.

Before applying any SWIR flame radiation correction, the SWIR pyrometer exhibited (as expected) TBC measurements that were not consistent in peak-to-peak magnitude, and that were significantly different in temperature between liquid fuel and natural gas firing. The response of both pyrometers, however, clearly distinguished the TBC surfaces from the metal surfaces (as shown in FIG. 1 for the LWIR case), for both fuels. Also, as expressed by Markham et al. (“Simultaneous Short and Long Wavelength Infrared Pyrometry . . . ”, supra), the higher LWIR temperatures measured, as compared to SWIR temperatures at TBC measurement, are regarded to point away from blade cooling lines (i.e., at points of largest decreasing temperature gradient into the TBC), and the convergence of the two measurements near cooling lines (i.e., at points of minimal temperature gradient into the TBC) is found to suggest the opportunity for distinguishing TBC surface temperature (using LWIR) and an average temperature through its thickness (using SWIR).

### SUMMARY OF THE INVENTION

It is a broad object of the present invention to provide a novel non-contact optical pyrometry method, and a novel radiation thermometer, by which the temperature, health and condition of a hot part can be monitored dynamically and in real time.

It is a more specific object of the invention to provide such a method and thermometer that are especially suited for obtaining accurate temperature data from, and for monitoring the health and condition of, a part, such as in particular the moving blade of a gas turbine, the part being comprised of a metal substrate coated with a ceramic thermal barrier material.

It has now been found that certain of the foregoing and related objects of the invention are attained by the provision of a radiation thermometer comprising, in combination: at least one hollow core optical waveguide having entry and exit ends and being comprised of a wall defining a bore therethrough; means for directing radiation upon the entry end of the waveguide; detector means effective for generating a first signal representative of the energy of short wavelength (SW) radiation (i.e., radiation in the near infrared and/or visible regions of the spectrum) impinging thereon, and for generating a second signal representative of the energy of long wavelength infrared radiation impinging thereon; and means connecting the detector means to the exit end of the waveguide to enable transmission to the detector means of radiation exiting from at least the bore of the waveguide.

In certain embodiments the connecting means of the thermometer will enable transmission of radiation exiting only from the bore of the waveguide. In those instances it is important that the bore (and normally, therefore, the waveguide itself) be relatively short and substantially uniform and rectilinear along its entire length, which length will generally not exceed about two feet. The “first” signal generated by the detector means will normally be representative of radiation of wavelengths in the range of about 0.35 to 5, and preferably about 0.7 to 1.2, microns; the “second” signal will normally be representative of radiation in the range of about 5 to 50, and preferably about 8 to 14, microns.

Although a single, suitably filtered broadband detector may for example be used, the detector means will usually comprise at least one “first” detector, operative for generating the “first” signal, and at least one “second” detector operative for generating the “second” signal. The means for connecting will normally be capable of discriminating between short wavelength radiation and long wavelength radiation, and will serve to direct the short wavelength radiation exiting from the primary waveguide(s) for impingement upon the first detector and to direct the exiting long wavelength radiation for impingement upon the second detector. More specifically, the connecting means will advantageously comprise a plurality of secondary waveguides, at least a first one of such secondary waveguides being constructed and disposed for efficiently transmitting radiation to the “first” detector and at least a second one thereof being constructed and disposed for efficiently transmitting radiation to the “second” detector.

The thermometer of the invention will usually additionally include electronic data acquisition means, operatively connected for receiving the “first” and “second” signals from the detector means, and electronic data processing means operatively connected and programmed for determining temperature values from signals received from the data acquisition means. The data processing means will generally be programmed for monitoring changes in the determined temperature values as well, and for correlating the long wavelength radiation signals to blackbody electromagnetic radiation, for determining actual temperature values.

In certain embodiments, the bore-defining wall of the “at least one waveguide” comprising the thermometer will be fabricated from a material that effectively transmits the short wavelength radiation, with the means for connecting enabling transmission of radiation exiting from the wall as well as from the bore of the waveguide. The waveguide wall will suitably be fabricated from silica or sapphire, and the inside surface of the wall, bounding the bore, will advantageously carry a coating of metallic dielectric structure; the waveguides will normally may be of flexible character.

In those embodiments in which separate detectors are used for generating the short and long wavelength signals, the means for connecting will desirably comprise a plurality of secondary waveguides, at least one of which will be constructed and disposed for efficiently transmitting radiation to one of the detectors and at least a second one of which will be constructed and disposed for efficiently transmitting radiation to another detector. A multiplicity of secondary waveguides, employed for transmitting short wavelength radiation to the first detector, may desirably be disposed to surround one or more secondary waveguides employed for transmitting long wavelength radiation (i.e., from the core of the primary waveguide). At least one of the ends of the primary waveguide wall will desirably be formed with a smooth, flat, polished surface to cooperate with a confronting, similarly formed, matching end face of the connecting means, normally disposed thereagainst.

Other objects of the invention are attained by the provision of a pyrometric method for monitoring the condition of a hot body comprised of a metal substrate coated with a ceramic thermal barrier material. In accordance with the method, long wavelength infrared radiance and short wavelength (i.e., near infrared and/or visible) radiance emitted from at least one spot on the surface of the hot body are simultaneously and repeatedly measured along a common axis and over a period of time. The long wavelength and short wavelength radiance measurements are utilized to obtain thermal emission data representative of, respectively, the surface temperature and the substrate temperature of the body, at the “at least one spot,” and the data obtained are analyzed to determine temperature changes that are, in turn, indicative of a change that has occurred in at least one physical feature of the body (e.g., surface contamination, a spall of the ceramic coating, or excessive part temperature). The radiance measurements may additionally be used to obtain data representative of radiance originating from one or more sources (e.g., a flame or an internal engine surface) and reflected from the hot body being monitored, for improved assessment of the health and condition of the part.

In an application of primary importance, the unique fiber waveguide sensor described herein effects simultaneous transfer of long wavelength and short wavelength radiance, and enables effective TBC turbine blade temperature and condition monitoring using a unitary engine probe and a common data system. More specifically, the present invention provides a sensor for a gas turbine engine which enables the important long wavelength radiation (˜10 microns) and short wavelength radiation (˜1 micron) to be measured simultaneously and coaxially through a single optical waveguide. TBC surface temperature, and average temperature through the TBC, can thereby be determined simultaneously; changes in TBC radiative properties can be readily monitored, and critically needed warning of TBC spall is provided. Thus, the sensor of the invention enables real-time operational inspection for impending catastrophic engine failure caused by excessive part temperature and/or by loss of TBC.

As discussed above, solid-core glass fiber optics are conventionally used for the transfer of SWIR (for example: silica for wavelengths less than ˜2 microns, sapphire for wavelengths less than ˜5 microns), but they cannot be used to transfer LWIR because they are opaque to those wavelengths. Conversely, while LWIR is propagated, with good throughput, in the air core (i.e., the passage) of a hollow waveguide by internal reflection, short wavelengths are usually quickly lost.

In accordance with the present invention, a unitary hollow waveguide, usually in the form of a thin-walled, flexible glass (silica) tube with a thin metallic dielectric coating applied to the inside wall, serves to transfer both LWIR and SW radiation, the long wavelengths being transferred by the internal passage and the short wavelengths being transferred by the material of the wall structure (or, in some instances, by the waveguide core). Such a probe receives the radiometric signals necessary for monitoring the health and performance of TBC engines parts (especially turbine blades), and constitutes an essential, on-engine component of the optimized “smart” pyrometer system described. It should be appreciated that the LWIR energy transfer capability of flexible hollow glass waveguides has previously been exploited for making on-rig and on-engine TBC temperature measurements, and that such hollow waveguides have been developed and used for biomedical laser applications.

### BRIEF DESCRIPTION OF THE DRAWINGS

FIGS. 1a) and 1b) are LWIR traces collected from an 80 blade gas turbine rotor using different fuels and engine power values;

FIG. 2 is a schematic diagram of a combination smart sensor system embodying the present invention and showing (on arbitrary scales) traces of surface temperature and TBC depth temperature;

FIG. 3A is a schematic diagram showing simultaneous transfer of LWIR and SWIR through the bore and wall of hollow core waveguide; FIG. 3B is a similar diagram showing simultaneous transfer of LWIR, SWIR and visible wavelengths through the hollow core of a straight, relatively short waveguide;

FIGS. 4A and 4B are, respectively, schematic diagrams of polished and unpolished hollow waveguide terminal end portions, and FIG. 4C is a schematic diagram of the terminal end portion of an assembly of secondary solid-core fibers for coupling to the primary hollow waveguide;

FIGS. 5a)-5c) are graphic depictions of measured detector noise levels;

FIG. 6 is a plot of spectral radiative properties of a free-standing TBC, with two measurements of each property being overlaid to show reproducibility;

FIG. 7a)-7c) are LWIR and SWIR temperature traces from a front-heated TBC blade, with different levels of internal cooling;

FIGS. 8a)-8c) are LWIR and SWIR temperature traces measured with different thickness of TBC on a metal substrate, and with a fireball positioned to reflect from the measurement spot; and

FIG. 9a) and 9b) are LWIR and SWIR temperature traces with and without flame reflection.

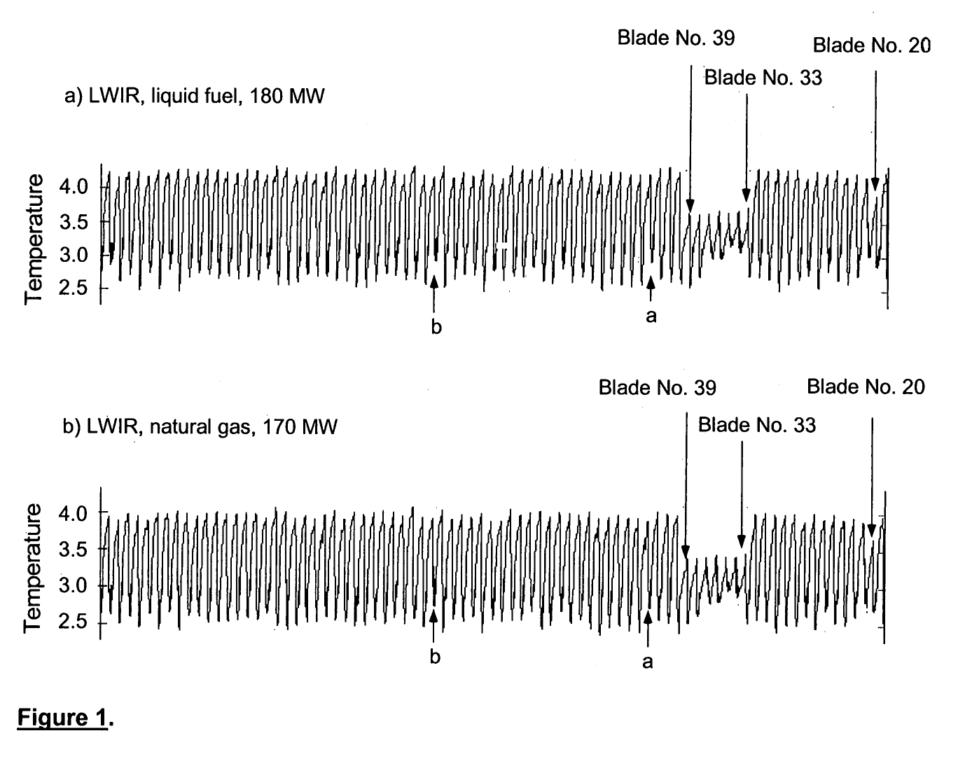

### DETAILED DESCRIPTION OF THE ILLUSTRATED AND PREFERRED EMBODIMENTS

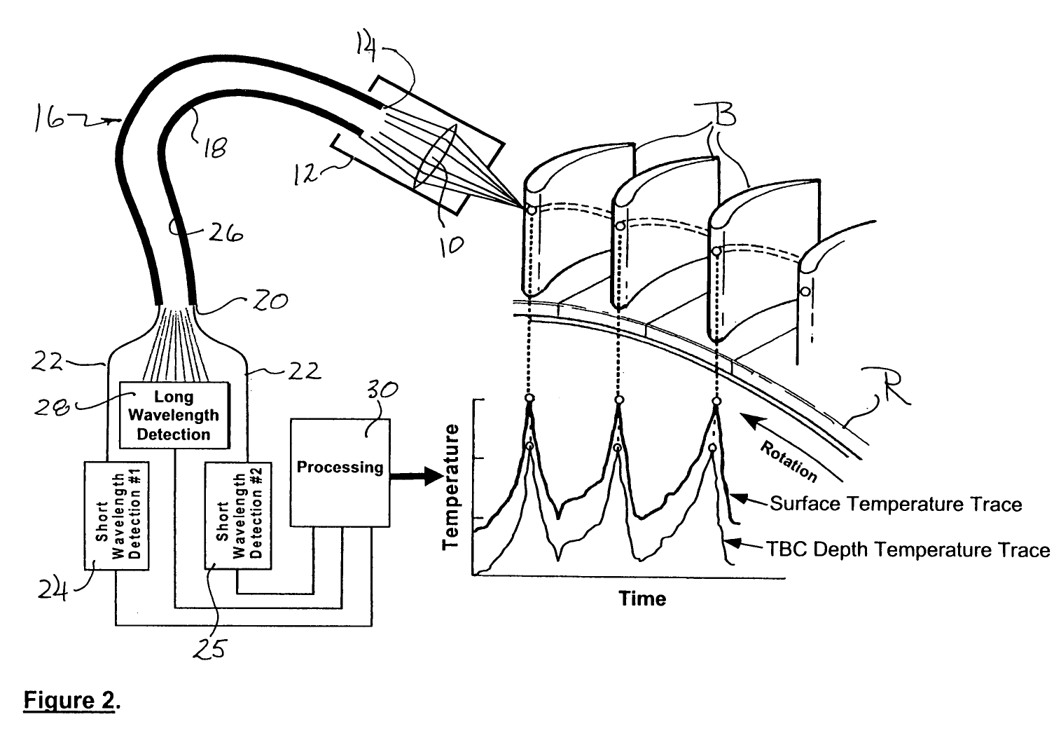

As depicted in FIG. 2 of the appended drawings, in utilizing the smart pyrometer system of the invention radiance is collected from the surface of each blade B of a turbine engine rotor R as it rotates (in the direction of the arrow) into the view of the lens 10 (zinc selenide is desirably used because it is rugged and is efficient in transferring both LW and SW energy), disposed in the engine mount 12 (which is essentially a probe body). The collected radiance is focused onto the polished end 14 of the hollow waveguide, generally designated by the numeral 16; as is schematically illustrated in FIG. 3A, SW components of the incident light propagate and are transferred through the wall 18 to the polished termination end surface 20, while LW components are transferred through the passage 26. As will be appreciated, the hollow waveguide 16 is in fact a fiber optic with a central bore that provides the passage 26. Small-diameter solid core glass fibers 22 (more fully described below) guide portions of the available SW radiance from the termination end surface 20, with which the fibers 22 are in alignment, to two SW detectors 24 and 25, and LW radiance is concurrently collected by detector 28, all for processing at 30 (e.g., by conventional electronic data acquisition and processing means). The Figure shows solid silica fibers 22, two SW detectors 24 and 25, and implies one LW detector 28. Other solid fiber materials that transmit SWIR, such as sapphire, can be used instead; and the LW detector 28 can be comprised of multiple detectors with appropriate split and direction of the LW radiance exiting from passage 26, or it can comprise one or more suitably filtered broadband detectors.

Hollow waveguides are commercially available typically with jagged “snapped-off” end portions, which can be secured in standard fiber optic hardware (i.e., SMA and ST connectors) to achieve lengths up to 10 meters. Albeit effective for LWIR radiation, it has been found that the efficient transfer of SW through the glass wall requires polishing of both ends of the hollow guide; a suitable fabrication technique is as follows:

Initially, the plastic coating (which is applied by the manufacturer for strength and flexibility) was stripped from opposite end portions of a 2 m length of 1.0 mm ID flexible hollow waveguide, having a 0.10 mm wall thickness. The end portions were then secured in 1.250 mm SMA fiber connectors with ˜10 mm of the waveguide protruding, taking care that the epoxy adhesive used for securing them surrounds the guide near the SMA connector without entering the hollow core. The guide was thereafter scored through the hardened epoxy to enable the terminal portions to be snapped off, leaving small sections (˜0.5 to 1 mm) protruding from the connectors. The end surfaces were then polished using standard methods but exercising particular care to avoid excessive pressure. It should be noted that, if the original soft plastic coating were not removed, the thin glass wall of the guide would tend to crumble during polishing, and it should be appreciated that the hard, well-adhered epoxy resin provides important structural support.

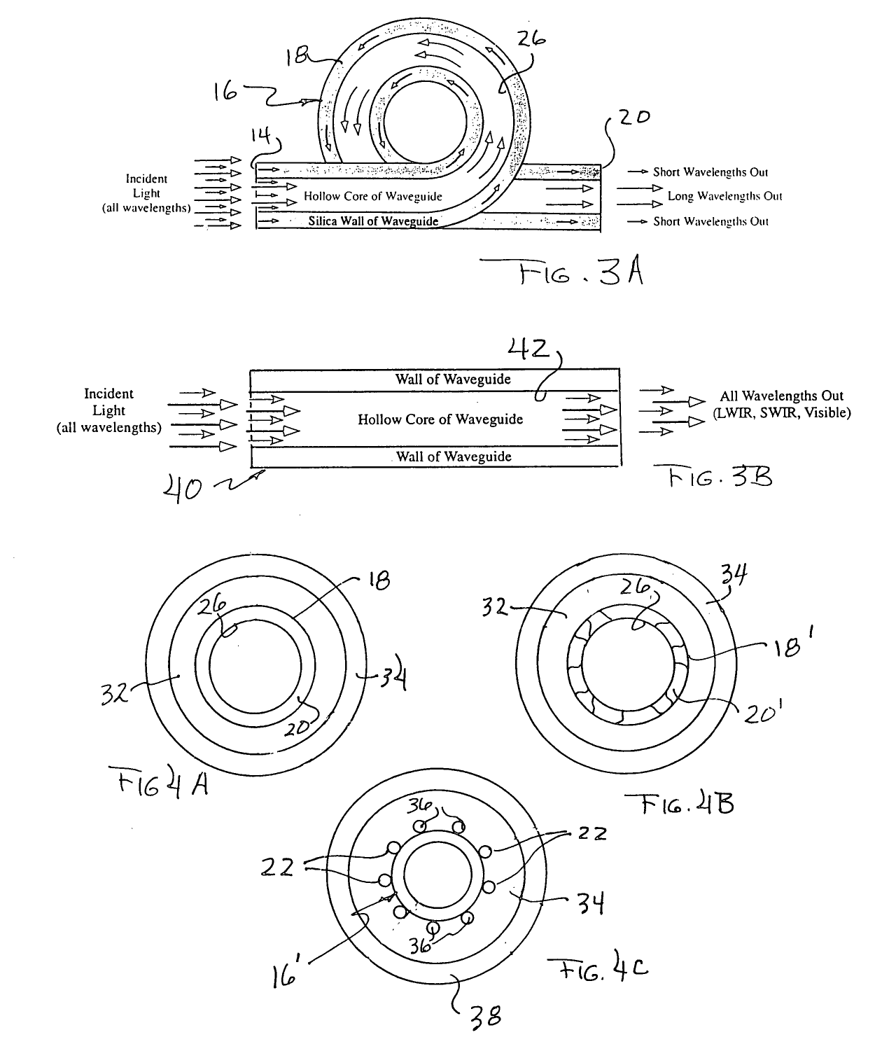

FIG. 4A illustrates a polished waveguide wall end surface 20, produced as described above. The waveguide wall 18 is secured by a deposit 32 of hardened epoxy resin within an SMA connector body 34. Visible light directed upon the opposite end of the guide and propagating down the wall is seen to exit with uniform intensity from the annular waveguide wall surface 20. In contrast, a complete lack of uniform intensity is seen in visible light exiting from an as-received commercial hollow waveguide, similarly illuminated, comprised of a wall 18′ having a jagged end surface 20′.

FIG. 4C shows the end surfaces 36 of nine 200 μm diameter solid core silica fibers 22, arranged and secured by an epoxy resin deposit 32 in an SMA connector 38 in surrounding relationship to a hollow core waveguide, generally designated by the numeral 16′, and polished as described, thereby providing a ring of fibers for collecting SW energy exiting the wall 18 of the hollow waveguide 16. An SMA mating sleeve was used to join the ring of solid fibers to the polished end of the waveguide wall in aligned, confronting relationship.

The LWIR energy passes from the bore of the primary hollow guide 16 into the bore of the similarly prepared secondary hollow guide 16′, to transmit the collected LWIR energy to the mercury-cadmium-telluride (MCT) detector 28. As suggested in FIG. 2, four of the nine solid fibers 36 were bundled to an indium gallium arsinide (InGaAs) SW detector 24 (having a peak response at 1.55 μm), and the remaining five fibers 36 were bundled to a silicon (Si) SW detector 25 (having a peak response at 0.96 μm).

As depicted in FIG. 3B, a hollow core primary waveguide, generally designated by the numeral 40, can be used to transmit all wavelengths of interest (i.e., LWIR, SWIR and visible) through its bore 42 only, if so desired, provided the bore is relatively short, straight and uniform. In such a waveguide the attenuation of radiation of short wavelengths that would otherwise occur is avoided, or is at least reduced sufficiently to make its use feasible.

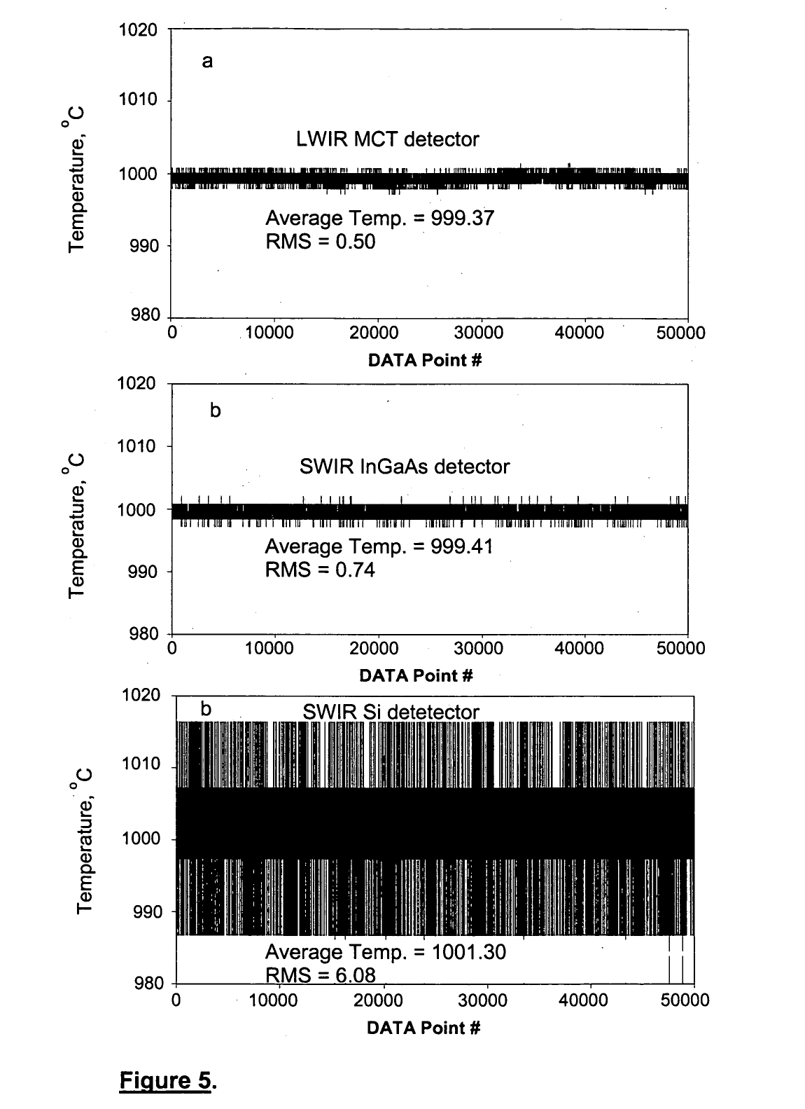

FIG. 5 presents temperature data (in the range 980° C. to 1020° C.), plotted as a function of data point number (0-50,000) and collected simultaneously, at 500 kHz, with the assembled and calibrated three-detector system shown in FIG. 2, when viewing into a commercially available blackbody calibrator (Micron M335 cavity source) stabilized at 1000° C. The Figure indicates that the “baseline” measurement noise levels on the LWIR MCT and SW InGaAs detectors are comparably low (RMS 0.59 MCT and 0.74 InGaAs), and that the Si detector exhibits much more measurement noise (RMS 6.08); switching the respective fiber bundles between the two SW detectors did not affect the observed noise levels. Although employed in work discussed below, therefore, it will be appreciated that the Si detector is not an essential (or indeed, due to the relatively high levelof measurement noise that can be produced, even a necessarily desirable) component of the pyrometer described.

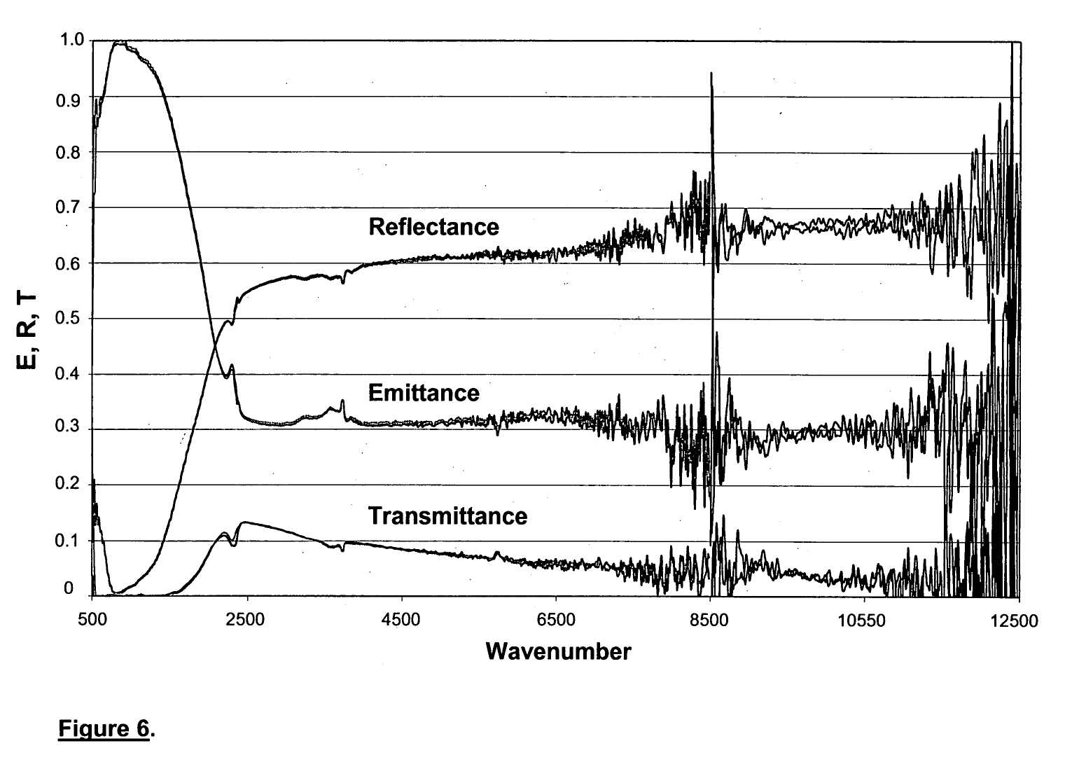

FIG. 6 presents spectral reflectance, transmittance and emittance traces for a free-standing TBC of 1.0 mm thickness, measured at a temperature near 1000° C. with a high-temperature spectral emissometer. The Figure plots wavenumber units (cm⁻¹) on the x-axis, which is the reciprocal of wavelength, and the following discussion includes the wavelength conversion in microns for all cm⁻¹ values. The wide spectral region shown, 500-12,500 cm⁻¹ (20-0.8 microns), is the composite of first measuring the 500-8,500 cm⁻¹ (20-1.18 microns) region with an MCT detector and then switching at temperature to an Si detector for the 8,500-12,500 cm⁻¹ (1.18-0.8 microns) region. The obvious “noise” near 8,500 cm⁻¹ (1.18 microns) and above 11,000 cm⁻¹ (0.91 micron) is due to detector cut-off (low response) in those regions. The small deflection at ˜2,400 cm⁻¹ (4.17 microns) is due to interference in the optical path due to CO₂ gas generated by the oxy/acetylene torch flame used to heat the sample.

It is seen that the TBC exhibits near-blackbody emittance in a narrow band in the LWIR at ˜1,000 cm⁻¹ (˜10 microns), and the operational wavelength of the LWIR component of the prototype is set to the near-blackbody region by way of a narrow bandpass filter. Transmittance (depth of penetration) and reflectance are significant in the SW region for either the InGaAs detector at ˜6450 cm⁻¹ (˜1.55 microns) or the Si detector at ˜10,416 cm⁻¹ (˜0.96 micron) of the prototype. For free-standing samples as thin as ˜0.1 mm, SWIR transmittance approaching 40% has been measured.

The following engine parts were measured with a combination sensor of the character described: 1) a TBC test bar that was manually filed along its length to the point of exposed metal, to gradually increase simulated spall; 2a) and 2b) a TBC blade exhibiting complete loss of TBC at the leading edge due to previous high-temperature rig testing; 3) a well-oxidized metal blade removed from an engine; and 4) a TBC blade section cut from an in-service blade that had turned reddish-brown in color (i.e., contaminated) after many hours of engine operation. The spectral emittance of these parts was also measured near 1000° C.

Table One below summarizes the emittance in the LWIR and SWIR for bandpasses, using the sensor system herein described.

TABLE ONE

| Engine Part | | LWIR Emittance | SWIR Emittance |
|---|---|---|---|
| 1) | TBC bar | 0.98 | 0.40 |
| 2a) | TBC blade, coated area | 0.97 | 0.38 |
| 2b) | TBC blade, uncoated area | 0.60 | 0.85 |
| | (oxidized metal) | | |
| 3) | uncoated oxidized metal blade | 0.55 | 0.85 |
| 4) | contaminated TBC | 0.97 | 0.67 |
| | blade section | | |

The differences in radiative properties for the TBC and oxidized metal surfaces are distinct. The three TBC surfaces exhibit near-blackbody emittance (near-zero reflectance) at the LWIR region. The two oxidized metal surfaces exhibit their lowest emittance (highest reflectance) in this LWIR region. Measured at SWIR, the two oxidized metal surfaces exhibit their highest emittance (lowest reflectance), while the TBCs are most reflective in this region.

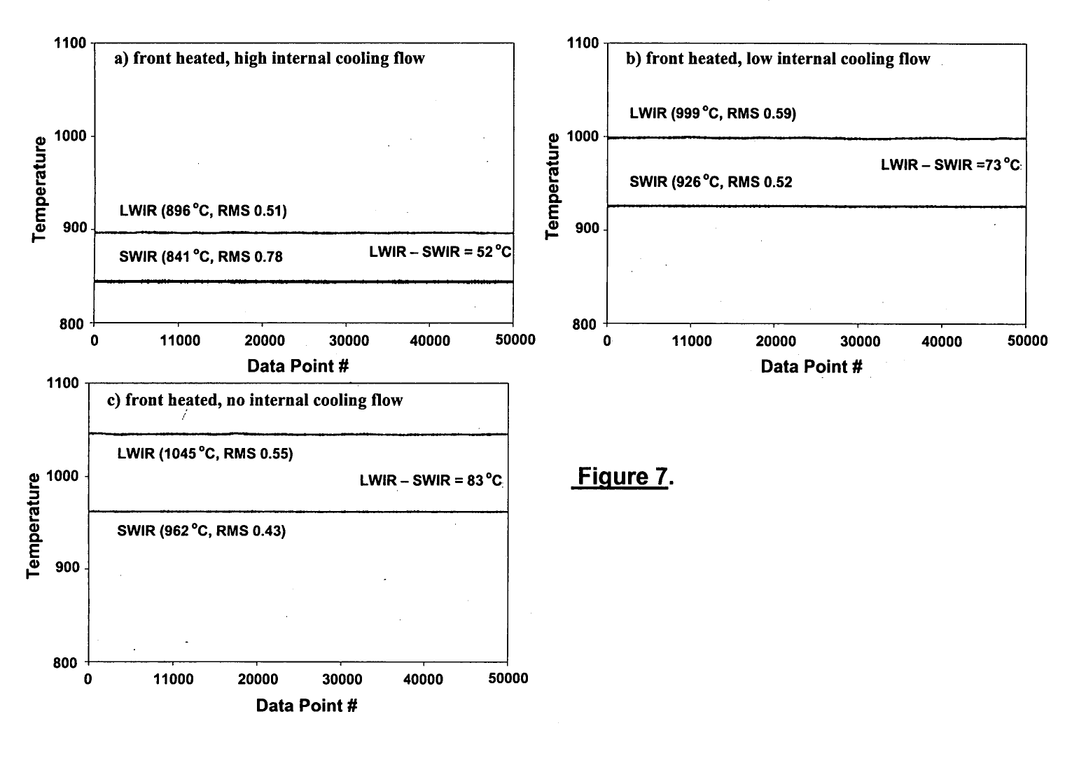

The foregoing parts were heated on the measured surface (“front heated”) with a oxy/acetylene torch flame (oxygen-rich, no soot), and in some cases, internal aircooling was also applied to the part. FIG. 7 presents simultaneous LWIR and SWIR temperature traces measured from part 2a (the TBC blade, coated area). These measurements are from the TBC for three settings of internal part gas cooling flow: high cooling flow (FIG. 7a); low cooling flow (FIG. 7b); and no cooling flow (FIG. 7c). Since constant front-heating is applied to the TBC, the expected temperature gradient would be decreasing into the TBC to the metal substrate, as on the leading edge and pressure surface of an in-service TBC blade. For this geometry, the measured LWIR temperature is always hotter than the SWIR temperature due to two contributing factors: i.e., the SWIR is “seeing” the temperature gradient through the TBC, and no compensation has been applied for the lower SWIR emittance.

The series of traces comprising FIG. 7 clearly shows the influence on the temperature gradient as internal cooling is decreased. Both LWIR and SWIR respond with an increase in temperature, but the difference in temperature (shown as LWIR-SWIR) also increases. In FIG. 7a, the high flow of internal cooling minimizes both the TBC surface temperature (LWIR) and the difference between the LWIR and SWIR readings (LWIR minus SWIR). In FIG. 7b, only the internal cooling flow is changed (decreased), the torch heating and radiative properties being maintained constant. Both LWIR (surface temperature) and SWIR (depth temperature) increase, and LWIR-SWIR also increases. The LWIR surface temperature and LWIR-SWIR are maximized when the internal cooling is stopped in FIG. 7c (again, with the other parameters constant). For all three conditions, the LWIR provides the quantitative measurement of TBC surface temperature, and the SWIR adds information on the increasing gradient through the TBC. Related to on-engine measurement for a turbine starting with identical TBC blades, an increase at a blade spot in both LWIR and SWIR temperature, and an increase in the difference between the two (i.e., increase in gradient), is believed to provide an early signal for failure of internal cooling flow due, for example, to cooling line plugging (a concern in gas turbine engines).

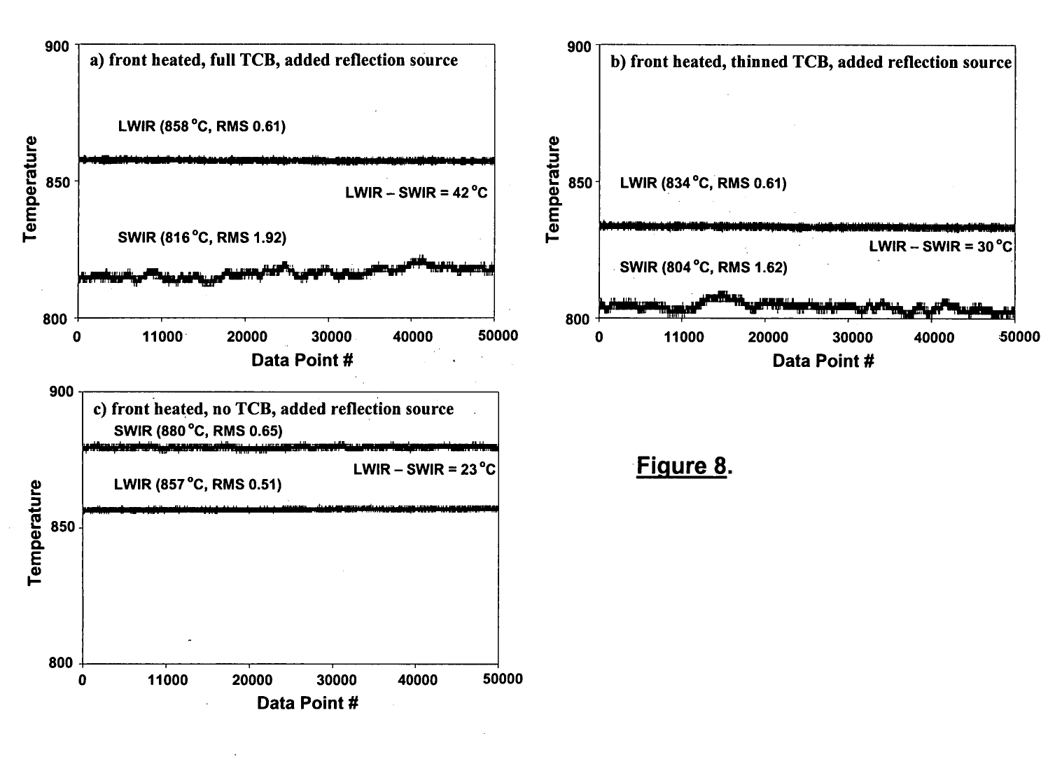

The next series of simultaneous measurements, taken on part 1 of Table One, shows the change in response at each wavelength as the TBC thins to exposed metal (simulating spallation). Added to the experiment is a nearby, highly radiating (sooty) acetylene flame, which serves to mimic the upstream fireball in an engine. In FIG. 8a, on the full thickness of TBC, the reflection contribution of the flickering fireball is evidenced by the random waviness to the SWIR trace. In the LWIR, however, where the TBC is near-blackbody in emittance, reflection contribution is nil and thus the temperature trace is steady. In FIG. 8b, where the TBC is thinner, both temperature traces show a decrease in temperature since the exposed TBC surface is now closer to the substrate, which is drawing heat away. The gradient is also decreased, as indicated by the decrease in the temperature difference between the two traces.

In FIG. 8c, where bare metal is exposed and oxidized, the SWIR now indicates a higher temperature than the LWIR due to the drastic shift in emittance between a TBC surface and oxidized metal surface in both wavelength regions. Since the SWIR emittance is now higher for the exposed metal, the reflection interference from the flickering fireball is decreased. However, the flickering fireball is not observed to add interference to the LWIR signal from the exposed metal; it is believed that the positioning of the flickering flame, at ˜45° input angle to the measurement field-of-view, influence this observation.

Related to on-engine measurements for a turbine starting with identical TBC blades, it is believed that spall for a blade spot can be detected by a decrease in the difference between the LWIR and SWIR readings, which is opposite to the increase in the difference observed when internal blade cooling begins to fail, as shown in FIG. 7. This suggests that the failure of internal blade cooling would lead to a rise in TBC surface temperature and gradient (shown in FIGS. 7a-c), which could then lead to TBC spall where the gradient then begins to decrease (shown in FIG. 8).

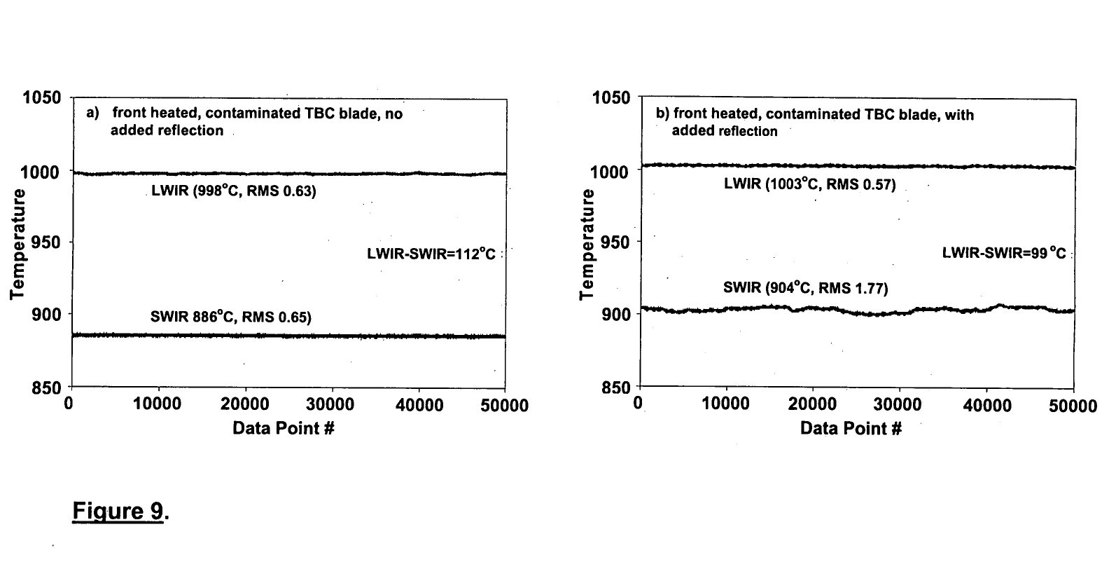

In FIG. 9, a second contribution of fireball radiance is indicated in the SWIR measurements from TBC. Measured here is part 4, the contaminated TBC blade section, which has maintained its LWIR emittance (0.97) but with an increase in SWIR emittance from 0.38 to 0.67 (i.e., lower SWIR reflectance) as indicated previously in Table One. In FIG. 9a, with no fireball present, the SWIR trace is 112° C. lower than the LWIR trace; the SWIR penetration depth is still significant with the contamination. When the fireball is added in FIG. 9b, the flickering reflection is again only observed in the SWIR, but there is also a significant 18° C. “stepped” increase to the SWIR trace; the LWIR signal increases by only 5° C. Data were collected immediately upon lighting the fireball so that radiative heating of the TBC part by this added energy source would be minimized. The reflection of the fireball adds a significant “stepped” increase (fireball continuum radiation) in addition to the waviness (flame flicker) observed in the SWIR trace.

Related to on-engine measurements for a turbine starting with identical TBC blades, it is believed that monitoring fluctuation from a point on a blade on the turbine, when compared over sequential turbine revolutions, can be used for health/condition monitoring, for spall detection, and for changes in the radiative properties (emittance, reflectance, transmittance) of the TBC due to contamination. For example, a new TBC (highest SWIR reflectance) would exhibit the highest level of random SWIR temperature fluctuation due to flame flicker, but as contamination increases (decrease in SWIR reflectance) the magnitude of fluctuation would decrease. If the contaminated surface flaked off, exposing higher reflecting, like-new TBC, a rise in SWIR fluctuation magnitude would be observed. This signal, combined with the magnitude and differences between the LWIR and SWIR signals, may be used to provide an early warning before catastrophic failure occurs.

It will be appreciated that modifications can of course be made in the embodiments of the thermometer and method described without departing from the scope from the appended claims. For example, rather than comprising secondary waveguides or the like, the connecting means may simply be means for coupling a detector directly to the exit end of the primary waveguide.

Thus, it can be seen that the present invention provides a novel non-contact optical pyrometry method, and a novel radiation thermometer, by which the temperature, health and condition of a hot part can be monitored dynamically and on a real-time basis. The method and thermometer of the invention are especially suited for obtaining accurate temperature data from, and for monitoring the health and condition of, a part, such as in particular a moving turbine blade (and normally a multiplicity of rotor blades), comprised of a metal substrate coated with a ceramic thermal barrier material. The on-engine radiation thermometer described simultaneously measures LWIR and SW radiation passing coaxially through a common optical waveguide.

Having thus described the invention, what is claimed is:

1. A radiation thermometer comprising, in combination:
at least one hollow core optical waveguide having entry and exit ends and being comprised of a wall defining a bore therethrough;
means for directing radiation upon said entry end of said waveguide;
detector means effective for generating a first signal representative of the energy of short wavelength radiation, inclusive of at least one of the near infrared and visible regions, impinging thereon, and for generating a second signal representative of the energy of long wavelength infrared radiation impinging thereon; and
means connecting said detector means to said exit end of said at least one waveguide to enable transmission to said detector means of radiation exiting from at least said bore of said at least one waveguide.

2. The thermometer of claim 1 wherein said bore of said at least one waveguide is substantially uniform and rectilinear along its entire length, and wherein the length of said at least one waveguide does not exceed about two feet.

3. The thermometer of claim 2 wherein said means for connecting enables transmission of radiation exiting only from said bore of said at least one waveguide.

4. The thermometer of claim 2 wherein said first signal is representative of radiation of wavelengths in the range of about 0.35 to 5 microns, and wherein said second signal is representative of radiation of wavelengths in the range of about 5 to 50 microns.

5. The thermometer of claim 4 wherein said first signal is representative of radiation in the range of about 0.7 to 1.2 microns, and wherein said second signal is representative of radiation in the range of about 8 to 14 microns.

6. The thermometer of claim 1 wherein said detector means comprises at least one first detector, operative for generating said first signal, and at least one second detector operative for generating said second signal.

7. The thermometer of claim 6 wherein said means for connecting discriminates between said short wavelength radiation and said long wavelength radiation, and directs said exiting short wavelength radiation for impingement upon said at least one first detector and directs said exiting long wavelength radiation for impingement upon said at least one second detector.

8. The thermometer of claim 6 wherein said means for connecting comprises plurality of secondary waveguides, at least a first one of said secondary waveguides being constructed and disposed for efficiently transmitting radiation to said at least one first detector, and at least a second one of said secondary waveguides being constructed and disposed for efficiently transmitting radiation to said at least one second detector.

9. The thermometer of claim 1 additionally including data acquisition means, operatively connected for receiving said first and second signals from said detector means, and electronic data processing means operatively connected and programmed for determining temperature values from signals received from said data acquisition means.

10. The thermometer of claim 9 wherein said data processing means is programmed for monitoring changes in said temperature values determined.

11. The thermometer of claim 9 wherein said data processing means is programmed to correlate said long wavelength radiation signals to blackbody electromagnetic radiation for determining such temperature values.

12. The thermometer of claim 1 wherein said wall of said at least one waveguide is fabricated from a material that effectively transmits said short wavelength radiation, and wherein said means for connecting enables transmission of radiation exiting from said wall of said at least one waveguide as well as radiation exiting from said bore thereof.

13. The thermometer of claim 12 wherein said waveguide wall is fabricated from a material selected from the group consisting of silica and sapphire.

14. The thermometer of claim 12 wherein the inside surface of said wall, bounding said bore of said waveguide, carries a coating of metallic dielectric structure.

15. The thermometer of claim 12 wherein said waveguide is flexible.

16. The thermometer of claim 12 wherein said detector means comprises at least one first detector, operative for generating said first signal, and at least one second detector operative for generating said second signal.

17. The thermometer of claim 16 wherein said means for connecting comprises a plurality of secondary waveguides, at least a first one of said secondary waveguides being constructed and disposed for efficiently transmitting radiation to said at least one first detector, and at least a second one of said secondary waveguides being constructed and disposed for efficiently transmitting radiation to said at least one second detector.

18. The thermometer of claim 17 wherein a multiplicity of said secondary waveguides for transmitting radiation to said at least one first detector are disposed about said at least a second one of said secondary waveguides.

19. The thermometer of claim 12 wherein at least one of said entry and exit ends of said waveguide wall has a smooth, flat, polished surface thereon.

20. The thermometer of claim 19 wherein said means for connecting has a end face formed for optically matching substantially said exit end waveguide wall surface, disposed in confronting relationship thereto.

21. A pyrometric method for monitoring the condition of a hot body comprised of a metal substrate having a ceramic thermal barrier coating thereon, comprising:
repeatedly measuring over a period of time, simultaneously and along a common axis, long wavelength infrared radiance and short wavelength radiance, inclusive of at least one of the infrared and visible regions, emitted from at least one spot on the surface of said hot body;
utilizing said long wavelength and short wavelength radiance measurements to obtain thermal emission data representative of, respectively, the surface temperature and the substrate temperature of said body at said at least one spot; and
analyzing said data to determine changes, indicative of at least one physical feature of said body, that occur in said temperatures during said period of time.

22. The method of claim 21 wherein said indicated physical feature of said body is at least one of: surface contamination, spall of said ceramic coating, and excessive part temperature.

23. The method of claim 21 wherein said radiance measurements are additionally used to obtain data representative of radiance originating from one or more sources and reflected from said hot body.

24. The method of claim 23 wherein said indicated physical feature of said body is at least one of: surface contamination and spall of said ceramic coating.
